(19) United States
(12) Patent Application Publication
(10) Pub. No.: US 2026/0067801 A1
(43) Pub. Date: Mar. 5, 2026

(54) STATIONARY MODE DETECTION TECHNIQUES

(71) Applicant: GOOGLE LLC, Mountain View, CA (US)

(72) Inventors: Chengzhi Li, San Diego, CA (US); Jose Andres Cesares Cano, Nuremberg (DE); Peter Pui Lok Ang, San Diego, CA (US)

(21) Appl. No.: 19/050,849

(22) Filed: Feb. 11, 2025

Related U.S. Application Data
(60) Provisional application No. 63/687,949, filed on Aug. 28, 2024.
(60) Provisional application No. 63/687,952, filed on Aug. 28, 2024.

(51) Int. Cl. H04W 52/02

(52) U.S. Cl. CPC H04W 52/0209

(57) ABSTRACT

A method includes performing, at a user equipment (UE), a one-shot detection during a first time period to detect whether a first set of stationary mode conditions are satisfied to transition from a first stationary mode to a second stationary mode. Responsive to the one-shot detection, the method further includes executing a sequential detection during a second time period after the first time period to confirm whether to switch to the second stationary mode.

### BACKGROUND

Energy consumption management by smartphones and other user equipment (UE) has become a focus for enhancing user experience. As these devices have evolved to provide a broad array of functionalities beyond basic communication, their energy requirements have significantly increased. This increase in functionality and dependence has highlighted the importance of energy efficiency, with a particular emphasis on reducing battery consumption during periods of inactivity. Parallel to these concerns, advancements in smartphone technology have notably expanded the radio capabilities of these devices. Each new generation of smartphones introduces improved communication features, which, despite their benefits, lead to increased power usage. A substantial part of this increased energy consumption is due to the continuous monitoring and management of frequency bands necessary for maintaining network connectivity. This function, identified as Third Generation Partnership Project (3GPP) Radio Resource Management (RRM), plays a substantial role in the operation of smartphones. However, RRM is also a significant source of power drain.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an example of a wireless system employing a UE configured to implement device-assisted stationary modes for reducing RRM activities and related energy consumption in accordance with some embodiments.

FIG. 2 is an example of a hardware configuration of the UE of FIG. 1 in accordance with some embodiments.

FIG. 3 is an example of a flowchart illustrating a stationary mode detection technique that is implemented by the UE of FIGS. 1 and 2 in accordance with some embodiments.

FIG. 4 is an example state machine diagram for transitioning between different stationary modes (in this example, high stationary mode, full stationary mode, and non-stationary mode) in accordance with some embodiments.

FIG. 5 is an example of a graph illustrating the progress through different stationary modes of a UE implementing the stationary mode detection technique of FIG. 3 in accordance with some embodiments.

FIG. 6 is an example of a diagram illustrating different stationary modes employed by the UE of FIGS. 1 and 2 in accordance with some embodiments.

### DETAILED DESCRIPTION

Stationary mode is a power saving feature where certain power intensive RRM operations, such as cell searches or reference signal measurements, are relaxed or even suspended when the UE is determined to have low mobility (e.g., when a user is sitting on a chair or walking at a slow speed) or in non-cell edge conditions. Therefore, in some cases, it is advantageous to maximize the amount of time that the UE is in stationary mode to conserve power. Conventional methods to trigger a transition to stationary mode involve a one-shot detection mechanism during a discontinuous reception cycle (DRX) to assess whether one or more stationary mode conditions are satisfied. The stationary mode conditions include determining whether a signal-to-interference-plus-noise ratio (SINR) meets a base SINR threshold and monitoring a variation in the reference signal receive power (RSRP) over a predetermined number of paging cycles with a base station. If the SINR is above the base SINR threshold (e.g., 2 dB) and the RSRP variation is within a certain variability threshold (e.g., 4 dB) over a number of paging cycles (e.g., 5 paging cycles), the UE modem can trigger a transition to a stationary mode to reduce the frequency of cell searches and reference signal measurements compared to non-stationary mode, thereby conserving power. If the UE is already in stationary mode and determines that the stationary mode conditions are no longer satisfied, the UE transitions to non-stationary mode during which the UE performs cell searches and measurements at a higher frequency.

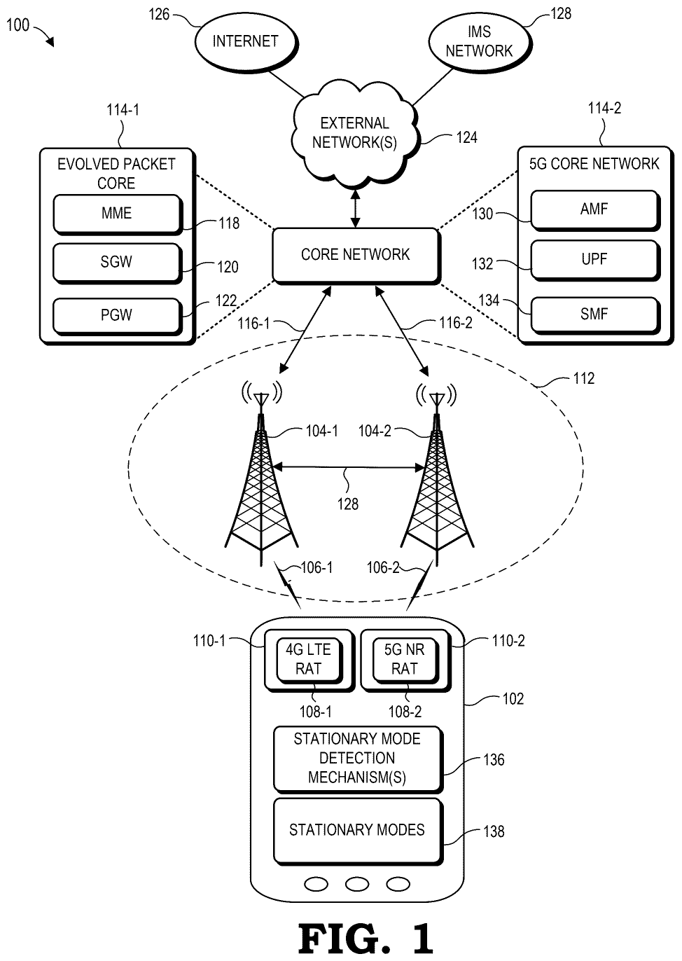

In noisy or other highly dynamic wireless environment scenarios, conventional methods may falsely identify conditions for transitioning between a stationary mode and a non-stationary mode due to signal fluctuations. In addition, the signal fluctuations can become more pronounced if the UE is in an RRC_IDLE mode where available cellular metrics are scarce due to the sleep periods during paging cycles. For example, the conventional one-shot detection mechanism may trigger a transition from a first stationary mode to non-stationary mode due to noise, signal fading, interference fluctuations, and the like, which may incorrectly indicate that the UE no longer satisfies the stationary mode conditions. This may lead to frequent switches between stationary mode and non-stationary mode so that the stationary mode power saving gains are significantly reduced. In some cases, if a UE leaves stationary mode due to signal fluctuations, it may require a relatively long amount of time (e.g., several minutes or more) to re-enter stationary mode. FIGS. 1-6 provide more robust stationary mode detection techniques to reduce the likelihood of dropping out of stationary mode in noisy or other highly dynamic wireless environment scenarios, thereby improving stationary mode power saving gains. In addition, the present disclosure provides an additional stationary mode (referred to as “deep stationary mode”) to serve as an intermediate stationary mode between high stationary mode and full stationary mode, thereby providing additional options for power savings.

To illustrate, in one embodiment, a method includes a UE performing a one-shot detection during a first time period to detect whether a first set of stationary mode conditions are satisfied to determine whether to transition from a first stationary mode to a second stationary mode. The first time period, for example, is a first portion of a DRX cycle, and the first set of stationary mode conditions include determining whether a base SINR threshold and/or an RSRP threshold are met. The first stationary mode and the second stationary mode are different modes selected from a full stationary mode, a deep stationary mode, a high stationary mode, and a non-stationary mode which progressively consume increasing amounts of power to perform cell searches and measurements (i.e., full stationary mode consumes the least amount of power and non-stationary mode consumes the highest amount of power). Responsive to the one-shot detection detecting that the one or more stationary mode conditions are satisfied, the UE executes a sequential detection during a second time period to determine whether a second set of stationary mode conditions are satisfied prior to transitioning from the first stationary mode to the second stationary mode. The second time period is after the first time period, and may occur, for example, during the same DRX cycle as the first time period or may occur after the DRX cycle of the first time period. In some cases, the sequential detection includes an update that involves utilizing a counter to assess whether the first conditions are satisfied over a pre-determined time period (e.g., larger than and including the first time period) to confirm that the transition from the first stationary mode to the second stationary mode is warranted. In this manner, by employing sequential detection to confirm the assessment of the one-shot detection, the UE is able to reduce the frequency of unwarranted transitions between stationary modes (e.g., ping-ponging between stationary mode and non-stationary mode) which may be caused by noisy or high interference environments, thereby improving stationary mode power saving gains.

For ease of illustration, the following techniques are described in an example context in which one or more UEs and one or more radio access networks (RANs) implement at least a Fourth Generation (4G) Long-Term Evolution (3GPP LTE) standard (e.g., 3GPP Release 8, Release 9, Release 10, etc.) or a Fifth Generation (5G) New Radio (NR) standard (e.g., 3GPP Release 15, 3GPP Release 16, 3GPP Release 17, etc.) (hereinafter, “5G NR” or “5G NR standard”). However, it should be understood that the present disclosure is not limited to networks employing an LTE or 5G NR RAT configuration, but rather, the techniques described herein can be applied to any RAT employed at the UEs and the RANs that implement RRM mobility operations or an equivalent thereof. It should also be understood that the present disclosure is not limited to any specific network configurations or architectures described herein for implementing stationary modes at UEs. Instead, techniques described herein can be applied to any configuration of RANs. Also, the present disclosure is not limited to the examples and context described herein, but rather, the techniques described herein can be applied to any network environment where a UE implements stationary modes.

FIG. 1 illustrates an example of a mobile cellular network 100 (also referred to here as “cellular network 100” or “network 100”) in accordance with at least some embodiments. As shown, the mobile cellular network 100 includes a device, such as a UE 102, that is configured to communicate with one or more base stations (BS) 104 (illustrated as BS 104-1 and BS 104-2) through one or more wireless communication links 106 (illustrated as wireless links 106-1 and 106-2). The UE 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE 102 employs a single RAT 108. In other embodiments, the UE 102 is a multi-mode UE that employs multiple RATs 108 (illustrated as RAT 108-1 and RAT 108-2). Examples of multiple RATs include cellular-based RATs, such as a 3GPP Long-Term Evolution (3GPP LTE) RAT, a 3GPP Fifth Generation New Radio (5G NR) RAT, a wireless local area network (WLAN) RAT, and the like. It should be understood that although FIG. 1 only shows the UE 102 implementing two different RATs 108, the UE 102, in at least some implementations, implements three or more different RATs 108. In at least some embodiments, one or more RAT modules 110 (illustrated as RAT module 110-1 and RAT module 110-2) manage the RATs 108 and enable communication between the UE 102 and the radio access technology of the network 100. The one or more RAT modules 110, in at least some embodiments, include one or more of a modem chipset(s) of the UE 102, a protocol stack(s), driver software, and the like.

In at least some embodiments, the BSs 104 are implemented in a macrocell, microcell, small cell, picocell, and the like, or any combination thereof. Examples of base stations 104 include an Evolved Universal Terrestrial Radio Access Network Node B (E-UTRAN Node B), Evolved Node B (eNodeB or eNB), Next Generation (NG or NGEN) Node B (gNode B or gNB), and so on. The BSs 104 communicate with the UE 102 via the wireless links 106, which are implemented using any suitable type of wireless link. The wireless links 106, in at least some embodiments, include a downlink of data and control information communicated from the base stations 104 to the UE 102, an uplink of data and control information communicated from the UE 102 to the BSs 104, or both. In at least some embodiments, the wireless links 106 (or bearers), such as data radio bearers (DRBs) and signal radio bearers (SRBs), are implemented using any suitable communication protocol or standard, or combination of communication protocols or standards, such as 3GPP 4G LTE, 5G NR, and so on. In at least some embodiments, multiple wireless links 106 are aggregated in a carrier aggregation to provide a higher data rate for the UE 102. Also, multiple wireless links 106 from multiple BSs 104 are configured, in at least some embodiments, for coordinated multipoint (CoMP) communication with the UE 102, as well as dual connectivity, such as single-RAT LTE-LTE or NR-NR dual connectivity, or multi-radio access technology (Multi-RAT) dual connectivity (MR-DC) including E-UTRA-NR dual connectivity (EN-DC), NGEN radio access network (RAN) E-UTRA-NR dual connectivity (NGEN-DC), and NR E-UTRA dual connectivity (NE-DC).

The BSs 104 collectively form a Radio Access Network (RAN) 112, such as an E-UTRAN or 5G NR RAN. The base stations 104 are connected to a core network (CN) 114 (illustrated as CN 114-1 and CN 114-2) via control-plane and user-plane interfaces through one or more links 116 (illustrated as link 116-1 and link 116-2). Depending on the configuration of the mobile cellular network 100, the core network 114 is either an Evolved Packet Core (EPC) network 114-1 or a 5G Core Network (5GC) 114-2. For example, in an E-UTRAN configuration or a 5G non-standalone (NSA) EN-DC configuration, the core network 114 is an EPC network 114-1 that includes, for example, a Mobility Management Entity (MME) 118, a Serving Gateway (SGW) 120, and a Packet Data Network Gateway (PGW) 122. The MME 118 provides control-plane functions, such as registration and authentication of multiple UEs 102, authorization, mobility management, and so on. The SGW 120 transfers user-plane packets related to audio calls, video calls, Internet traffic, and the like. The PGW 122 provides connectivity from the UE 102 to external packet data networks 124, such as the Internet 126 and an Internet Protocol Multimedia Subsystem (IMS) network 128, by being the point of exit and entry of traffic for the UE 102. In a 5G standalone (SA) configuration or an NSA NE-DC or NGEN-DC configuration, the core network 114 is a 5GC network 114-2. The 5GC 114-2 includes, for example, an Access and Mobility Management function (AMF) 130, a User Plane Function (UPF) 132, and a Session Management Function (SMF) 134. The AMF 130 provides control-plane functions such as registration and authentication of multiple UEs 102, authorization, mobility management, and so on. The UPF 132 transfers user-plane packets related to audio calls, video calls, Internet traffic, and the like. The SMF 134 manages protocol data unit (PDU) sessions.

In at least some embodiments, the core network 114 communicatively couples the UE 102 to an IMS network 128 via the RAN 112. The IMS network 128 provides various IMS services to the UE 102, such as IMS short messages, IMS unstructured supplementary service data (USSD), IMS value-added service data, IMS supplementary service data, IMS voice calls, and IMS video calls. To this end, an entity (e.g., a server or a group of servers) operating in the IMS network 128 supports packet exchange with the UE 102. The packets convey signaling (such as session initiation protocol (SIP) messages, IP messages, or other suitable messages) as well as data (or media), such as voice or video. In at least some embodiments, the IMS network includes entities (not shown) such as a Proxy Call Session Control Function (P-CSCF), an Interrogating Call Session Control Function (I-CSCF), a Serving Call Session Control Function (S-CSCF), a Home Subscriber Server (HSS), a Media Gateway Control Function (MGCF), and the like.

As described above, optimizing user experience at a UE 102 involves balancing advanced functionality with power management, especially since energy consumption is critical during periods of inactivity. The introduction of advanced radio communication technologies has improved connectivity but also increased power consumption, largely due to the continuous network monitoring performed for 3GPP RRM, which significantly impacts battery life. Therefore, the UE(s) 102 of one or more embodiments employs at least one stationary mode detection mechanism 136 that accurately detects when the UE 102 is in a low mobility state (e.g., still or moving at a walking velocity) and employs one or more stationary modes 138 during which RRM activities (e.g., signal measurements or cell searches) are reduced for conserving energy at the UE 102.

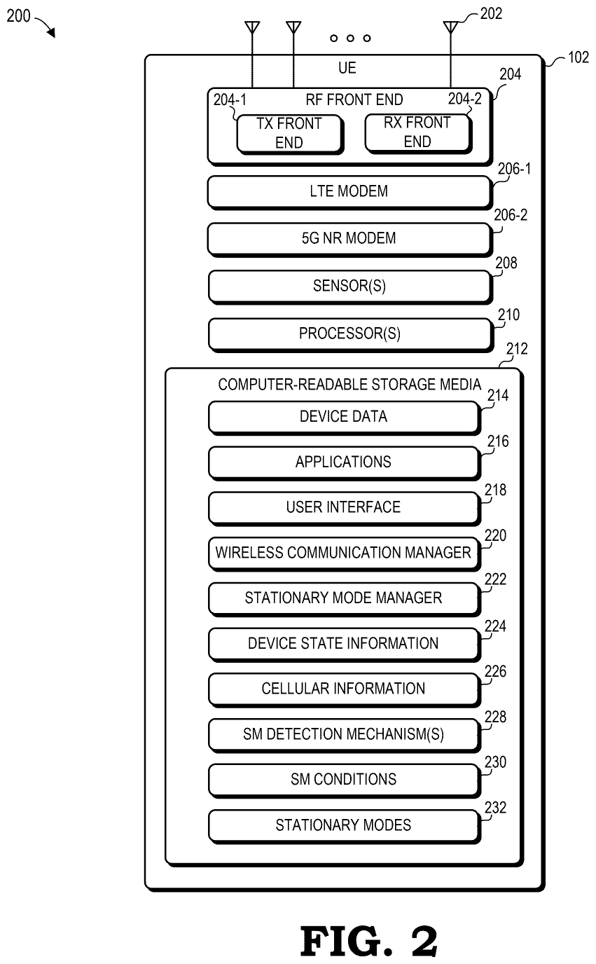

FIG. 2 illustrates an example device diagram 200 of a UE 102. In at least some embodiments, the device diagram 200 describes a UE that implements the device-assisted stationary mode detection techniques described herein. The UE 102 may include additional functions and interfaces that are omitted from FIG. 2 for the sake of clarity. The UE 102, in at least some embodiments, includes antennas 202, a radio frequency (RF) front end 204, and one or more RF transceivers 206 (e.g., a 3GPP 4G LTE transceiver 206-1 and a 5G NR transceiver 206-2) for communicating with one or more base stations 104 in a RAN 112, such as a 5G RAN, an E-UTRAN, a combination thereof, and so on. In at least some embodiments, the RF transceivers 206 are RF modems, and thus are also referred to herein as “RF modem 206”. The RF front end 204, in at least some embodiments, includes a transmitting (Tx) front end 204-1 and a receiving (Rx) front end 204-2. The Tx front end 204-1 includes components such as one or more power amplifiers (PA), drivers, mixers, filters, and so on. The Rx front end 204-2 includes components such as low-noise amplifiers (LNAs), mixers, filters, and so on. The RF front end 204, in at least some embodiments, couples or connects the one or more RF transceivers 206, such as the LTE transceiver 206-1 and the 5G NR transceiver 206-2, to the antennas 202 to facilitate various types of wireless communication.

In at least some embodiments, the antennas 202 of the UE 102 include an array of multiple antennas configured similarly to or different from each other. The antennas 202 and the RF front end 204, in at least some embodiments, are tuned to or are tunable to one or more frequency bands, such as those defined by the 3GPP LTE, 3GPP 5G NR, IEEE wireless local area network (WLAN), IEEE wireless metropolitan area network (WMAN), or other communication standards. In at least some embodiments, the antennas 202, the RF front end 204, the LTE transceiver 206-1, and the 5G NR transceiver 206-2 are configured to support beamforming (e.g., analog, digital, or hybrid) or in-phase and quadrature (I/Q) operations (e.g., I/Q modulation or demodulation operations) for the transmission and reception of communications with one or more base stations 104. By way of example, the antennas 202 and the RF front end 204 operate in sub-gigahertz bands, sub-6 GHz bands, above 6 GHz bands, or a combination of these bands defined by the 3GPP LTE, 3GPP 5G NR, or other communication standards.

In at least some embodiments, the antennas 202 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 202, the UE 102 can form beams that are steered or un-steered, wide or narrow, or shaped (e.g., as a hemisphere, cube, fan, cone, or cylinder). The one or more transmitting antennas may have an un-steered omnidirectional radiation pattern or may produce a wide steerable beam. Either of these techniques enables the UE 102 to transmit a radio signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE 102, in at least some embodiments, includes one or more sensors 208 implemented to detect various properties such as one or more of temperature, supplied power, power usage, battery state, and the like. Examples of sensors include a thermal sensor, a battery sensor, a power usage sensor, and so on.

The UE 102 also includes at least one processor 210. The processor 210, in at least some embodiments, is a single-core processor or a multiple-core processor composed of a variety of materials, such as silicon, polysilicon, high-K dielectric, copper, and so on. In at least some embodiments, the processor 210 is implemented at least partially in hardware, including, for example, components of an integrated circuit or a system-on-a-chip (SoC), a digital-signal-processor (DSP), an application-specific integrated circuit (ASIC), a field-programmable gate array (FPGA), a complex programmable logic device (CPLD), other implementations in silicon or other hardware, or a combination thereof.

Examples of the processor(s) 210 include a communication processor, an application processor, microprocessors, DSPs, controllers, and so on. A communication processor, in at least some embodiments, is implemented as a modem baseband processor, software-defined radio module, configurable modem (e.g., multi-mode, multi-band modem), wireless data interface, wireless modem, or so on. In at least some embodiments, a communication processor supports one or more of data access, messaging, or data-based services of a wireless network, as well as various audio-based communication (e.g., voice calls). An application processor, in at least some embodiments, provides computing resources to applications executing on the UE 102. For example, an application provides a self-contained operating environment that delivers system capabilities (e.g., graphics processing, memory management, and multimedia processing) to support applications executing on the UE 102.

The UE 102 further includes a non-transitory computer-readable storage media 212 (CRM 212). The computer-readable storage media described herein excludes propagating signals. The CRM 212, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 214 of the UE 102. In at least some embodiments, the device data 214 includes user data, multimedia data, beamforming codebooks, applications 216, a user interface(s) 218, an operating system of the UE 102, and so on, which are executable by the processor(s) 210 to enable user-plane communication, control-plane signaling, and user interaction with the UE 102. The user interface 218, in at least one embodiment, is configured to receive inputs from a user of the UE 102. In at least some embodiments, the user interface 218 includes a graphical user interface (GUI) that receives the input information via a touch input. In other instances, the user interface 218 includes an intelligent assistant that receives the input information via an audible input or speech. Alternatively, or additionally, the operating system of the UE 102 is maintained as firmware or an application on the CRM 212 and executed by the processor(s) 210.

The CRM 212, in at least some embodiments, also includes either or both of a wireless communication manager 220 and a stationary mode manager 222. Alternatively, or additionally, either or both of the wireless communication manager 220 and the stationary mode manager 222, in at least some embodiments, are implemented in whole or part as hardware logic or circuitry integrated with or separate from other components of the UE 102. In at least some embodiments, the wireless communication manager 220 configures the RF front end 204, the LTE transceiver (modem) 206-1, the 5G NR transceiver (modem) 206-2, or a combination thereof, to perform one or more wireless communication operations. The stationary mode manager 222, in at least some embodiments, implements the SM detection mechanism(s) 136, 228 based on the SM conditions 230 to trigger one of the stationary modes 138, 232 described herein. In particular, the stationary mode manager 222 detects when the UE is in a stationary state (e.g., still or moving at a walking velocity) based on the satisfaction of one or more of the SM conditions 230 and employs one or more stationary modes 138, 232 during which RRM activities are reduced for conserving energy at the UE 102. In at least some embodiments, the stationary mode manager 222 implements the SM detection mechanism(s) 136, 228 described herein in response to the UE 102 being in an inactive state, such as a Radio Resource Control (RRC) idle state. The sets of SM conditions 230 include, in some embodiments, a first set of stationary mode conditions that are utilized during a one-shot detection, and a second set of stationary mode conditions that are utilized during a sequential detection. The stationary modes 232 include, in some embodiments, a high stationary mode, a deep stationary mode, and a full stationary mode, which increasingly conserve power by relaxing or suspending RRM activities (i.e., full stationary mode conserves the most power). In some cases, the stationary modes 232 also include a non-stationary mode.

The CRM 212, in at least some embodiments, further includes one or more of the device state information 224, cellular information 226, stationary mode (SM) detection mechanism(s) 228, sets of stationary mode (SM) conditions 230, and stationary modes 232. Examples of the device state information 224 include device battery state information (e.g., plugged in, unplugged, battery level, power mode, etc.), sensor information (e.g., device thermals, angular velocity, linear acceleration, etc.), screen/display state information (e.g., screen on, screen off, screen share activated, in-car infotainment connectivity, etc.), telephony IP Multimedia System (IMS) state information (e.g., Voice over Wi-Fi (VoWiFi) connectivity information), WLAN connectivity information, mobile virtual network operator (MVNO) metrics (e.g., reliability in terms of stable throughput for data connections, audio quality metrics for voice calls, etc.), an indication of the default radio interface(s) (e.g., WLAN, cellular, etc.), a combination thereof, and the like. Examples of the cellular information 226 include radio frequency (RF) metrics, such as SINR, RSRP, SINR/RSRP slope estimation, neighbor cell metrics, and the like.

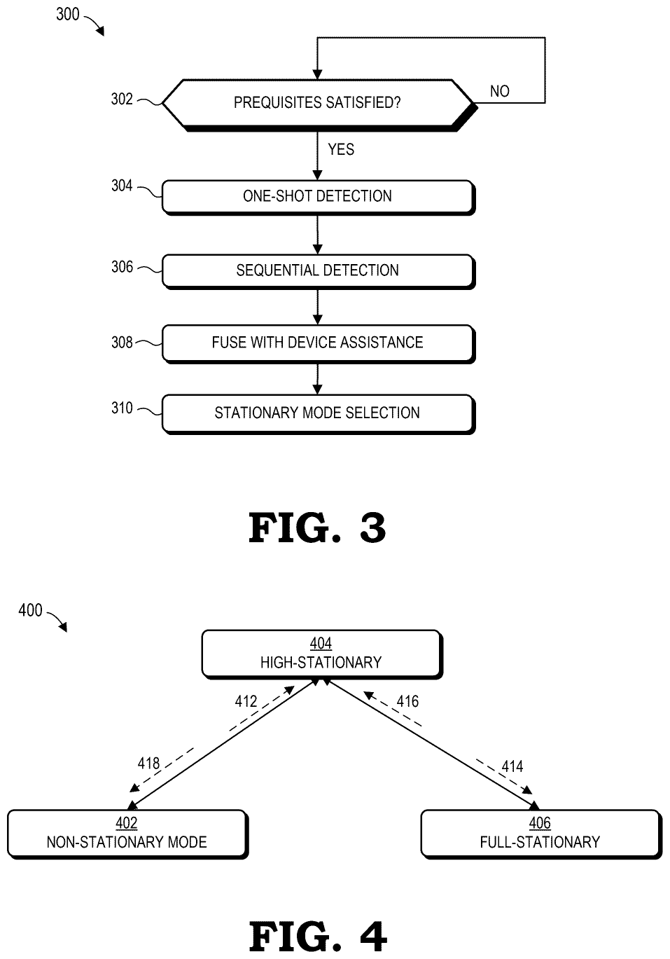

FIG. 3 is an example of a flow diagram 300 illustrating a stationary mode detection method according to some embodiments. The method of the flow diagram 300 is executed by the stationary mode detection mechanism(s) 136 of the UE 102 of FIG. 1 or a combination of the processor(s) 210 and the CRM 212 of the UE 102 of FIG. 2. In some embodiments, the method illustrated in flow diagram 300 is performed by the UE 102 every DRX cycle whether the UE 102 is in an RRC_CONNECTED state or an RRC_IDLE state.

At block 302, in some embodiments, the UE processor evaluates whether one or more prerequisite conditions are satisfied. In some embodiments, the one or more prerequisite conditions must be satisfied in order to qualify for a stationary mode such as high stationary mode, deep stationary mode, or full stationary mode. For example, in some cases, the prerequisite conditions include one or more of the serving cell not changing from the previous paging cycle and an SINR being above a prerequisite SINR threshold. In some cases, the prerequisite SINR threshold is an RRM_STATIONARY_SINR_LOW threshold with a predetermined value that is selected to ensure that a paging signal can be received. For example, the RRM_STATIONARY_SINR_LOW threshold value is −3 dB. In some embodiments, the prerequisite conditions must be satisfied whether the UE is an RRC_IDLE state or an RRC_CONNECTED state.

If the prerequisites are satisfied (i.e., YES at block 302), the UE proceeds to block 304. If the prerequisites are not satisfied (i.e., NO at block 302), the UE returns to block 302 to assess whether the prerequisites are satisfied in a subsequent DRX cycle. In addition, the UE enters (or stays in) non-stationary mode and resets a stationary mode counter.

At block 304, in some embodiments, the UE processor performs a one-shot detection. In some embodiments, the one-shot detection includes evaluating whether a first set of conditions for transitioning to (or from) one of a plurality of stationary modes is satisfied. For example, the first set of conditions includes one or more of: (1) evaluating whether an SINR is above an SINR threshold, and (2) evaluating whether an RSRP variation within the last n cycles (where n is a positive integer, e.g., n=5) is above an RSRP variation threshold. The SINR threshold is, for example, an RRM_STATIONARY_SINR_TH value such as 2 dB. The RSRP variation threshold is, for example, 4 dB. After assessing whether the one-shot detection conditions are satisfied, the method proceeds to block 306.

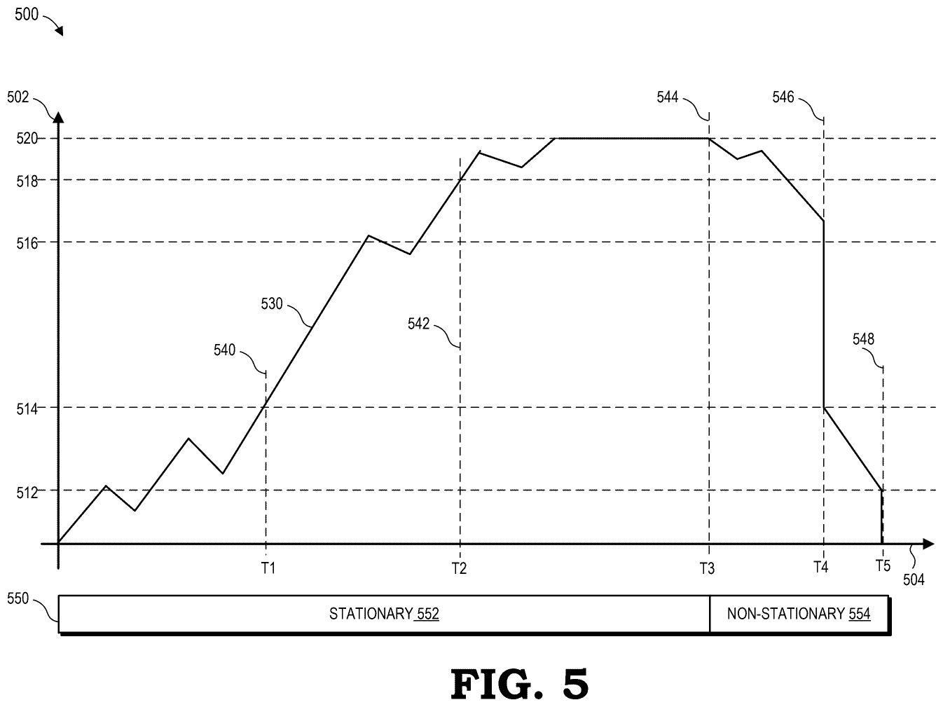

At block 306, in some embodiments, responsive to the one-shot detection conditions being satisfied or not, the UE performs a sequential detection. The sequential detection includes, in some aspects, performing a stationary mode counter update and assessing whether one or more sequential detection conditions are satisfied to select a stationary mode candidate. The stationary mode candidate is, in some cases, a stationary mode such as a high stationary mode, a deep stationary mode, or a full stationary mode, and, in other cases, the stationary mode candidate is a non-stationary mode. The sequential detection performed at block 306 includes updating a stationary mode counter (“Stationary_Mode_Counter”) every DRX cycle based on the one-shot detection performed at block 304: if the conditions of the one-shot detection are satisfied, the counter is incremented, and if the conditions of the one-shot detection are not satisfied, then the counter is decremented. Based on the status of the stationary mode counter, the UE assesses what sequential detection conditions are satisfied for the current DRX cycle in order to select the appropriate stationary mode candidate. That is, the UE selects a stationary mode candidate (e.g., non-stationary mode, high stationary mode, deep stationary mode, or full stationary mode) based on the execution of the sequential detection at block 306. A more detailed explanation for selecting a stationary mode candidate based on the sequential detection conditions is provided below in FIGS. 4 and 5. Responsive to performing the sequential detection at block 306 and selecting the stationary mode candidate, the UE proceeds to optional block 308 or directly to block 310.

At optional block 308, in some embodiments, the UE fuses the stationary mode candidate as determined by the sequential detection at block 306 with a device assistance information. In some cases, the device assistance information is the device data 214 and/or the device state information 224 of the UE 102 of FIG. 2. For example, the device assistance information includes, at least in part, a battery state information (e.g., battery level) and/or sensor information that is fused with the stationary mode candidate resulting from the sequential detection at block 306 to select a stationary mode at block 310.

In any event, responsive to execution of the sequential detection and the selection of the stationary mode candidate at block 306 (and, optionally, the fusing of the stationary mode candidate with the device assistance information at block 308), the UE is configured to select a stationary mode at block 310. In some cases, the selection of the stationary mode at block 310 involves transitioning between different stationary mode states depending on the UE's current stationary mode and the stationary mode candidate selected at block 306. FIG. 4 shows an example of a stationary mode state transition diagram 400 in accordance with some embodiments. The stationary mode state transition diagram 400 depicts the transitions between a non-stationary mode 402, a first stationary mode labeled as high-stationary mode 404, and a second stationary mode labeled as full-stationary mode 406. In other embodiments, the stationary mode state transition diagram 400 includes fewer stationary modes or additional stationary modes such as a third stationary mode (e.g., a deep stationary mode) between the first stationary mode and the second stationary mode.

For switching between the stationary modes 402, 404, 406, the UE employs a stationary mode detection mechanism (such as the SM detection mechanism(s) 136 and 228 of FIGS. 1 and 2, respectively) by initially setting a stationary mode counter (such as the aforementioned Stationary_Mode_Counter) to 0 and updating the counter at each DRX cycle based on the satisfaction of the one-shot detection. The UE then compares the updated counter value to one or more threshold for transitioning between the different stationary modes 402, 404, 406. For example, when the counter reaches a first threshold (referred to herein as “L_low” or L_{low}, where L_low is a first number, A, of counts from 0, and where the counts represent DRX cycles, and where A is a positive integer), the UE switches 412 from the non-stationary mode 402 to the high-stationary mode 404. When the counter reaches a second threshold (referred to herein as “L_high” or L_{high}, where L_high is a second number, B, and where the counts represent DRX cycles, and where B is a positive integer larger than A), the UE switches 414 from the high-stationary mode 404 to the full-stationary mode 406. In some aspects, the full-stationary mode 406 provides greater power saving gains than the high-stationary mode 404 (e.g., the full-stationary mode 406 has a lower frequency of RRM operations such as cell searches or reference signal measurements than the mode 404). When in the full-stationary mode 406 and the counter decreases by a first number of counts (referred to as a “d_s” or dₛ, where d_s is a third number, x, of counts that indicate a first offset from SCounterₘₐₓ) from the maximum counter value (SCounterₘₐₓ, which is a value greater than L_high), the UE transitions 416 from the full-stationary mode 406 to the high-stationary mode 404. And, when the counter ramps down a second number of counts (referred to as a “d_lm” or dₗₘ offset, where d_lm is a third number, y, of counts that is greater than x and that indicate a second offset from SCounterₘₐₓ) from the maximum counter value (SCounterₘₐₓ), the UE transitions 418 from the high-stationary mode 404 to the non-stationary mode 402, and the counter is reset to 0. As such, the time delay associated with the evaluation period to enter each of the different stationary modes is defined by the values for L_low, L_high, d_lm, and d_s. Examples of the values for these variables are provided below:

$$L\_high = 120 DRX cycles$$

$$L\_low = 56 DRX cycles$$

$$d\_lm = 15 DRX cycles$$

$$d\_s = 5 DRX cycles$$

In some embodiments, the sequential detection performed by the UE at block 306 is an algorithm that is defined by the following features. The algorithm defines SSₙ as the stationary status (SS) given by the one-shot detection in the n^{th} DRX cycle, where n is a positive integer. If the one-shot detection detects that the first set of conditions is met to declare stationary status, then SSₙ=TRUE, otherwise SSₙ=FALSE. In some embodiments, SSₙ is quantized according to the following:

$$Q ( S {S}_{n} ) = \{ 1 , if S {S}_{n} = TRUE - 1 , if S {S}_{n} = FALSE \qquad ( 1 )$$

The stationary status counter (SCounterₙ) is defined as:

$${SCounter}_{n} = min ( max ( {\sum }_{n} ( Q ( S {S}_{n} ) ) , 0 ) , {L}_{high} ) \qquad ( 2 )$$

That is, SCounterₙ is an accumulator that builds on the last n stationary status, limited between 0 and L_{high}. For example, if the UE determines that the one-shot detection is satisfied for the current DRX cycle, then the accumulator is incremented by one. If the one-shot detection is not satisfied for the current DRX cycle, then the accumulator is decremented by one.

Initially, SCounterₘₐₓ=0 and is adjusted based on the following:

$${SCounter}_{max} = max ( {SCounter}_{n} , {SCounter}_{max} ) \qquad ( 3 )$$

$$If {SCounter}_{n} \leq {SCounter}_{max} - {d}_{s} \qquad ( 4 )$$

where dₛ is the first offset from SCounterₘₐₓ that defines when to transition from full stationary mode to high stationary mode, and the UE is in full-stationary mode, the UE transitions to high-stationary mode, and

$${SCounter}_{n} = {L}_{Low} , \qquad ( 5 )$$

$${SCounter}_{max} = {L}_{Low} + {d}_{s} .$$

$$If {SCounter}_{n} \leq {SCounter}_{max} - {d}_{lm} ,$$

where dₗₘ>dₛ and is an offset from SCounterₘₐₓ (and is the maximum tolerance for the failures of the one-shot detection), the UE transitions to non-stationary mode and the counters are reset to 0.

Otherwise, if SCounterₙ=L_{Low}, the UE detects high-stationary mode. FIG. 5 illustrates an example of the procession through the above-described algorithm.

FIG. 5 illustrates a graph 500 showing an example of the sequential detection algorithm (e.g., the sequential detection at block 306 of FIG. 3) according to some embodiments. In the graph, the y-axis 502 represents the stationary status counter value, and the x-axis 504 represents time. Line 530 represents the stationary status counter value as a function of the DRX cycles (i.e., SCounterₙ). The bar 550 below the graph 500 represents the actual UE state.

On the y-axis 502, line 512 represents the SCounterₘₐₓ−dₗₘ value (i.e., the threshold for transitioning from high-stationary mode to non-stationary mode, or the transition 418 of FIG. 4); line 514 represents the L_{low} value (i.e., the threshold for transitioning from non-stationary mode to high-stationary mode, or the transition 412 of FIG. 4); line 516 represents the SCounterₘₐₓ−dₛ value (i.e., the threshold for transitioning from full-stationary mode to high-stationary mode, or the transition 416 of FIG. 4); line 518 represents the L_{high} value (i.e., the threshold for transitioning from high-stationary mode to full-stationary mode, or the transition 414 of FIG. 4); and line 520 represents the SCounterₘₐₓ value.

Also depicted in FIG. 5 is a bar 550 illustrating the actual state of the UE. The UE is stationary 552 during the first time period up to T3 represented by vertical dashed line 544, and the UE is non-stationary 554 after T3.

Initially, the UE is assumed to be stationary (and corresponding to actual stationary state 552) with good signal coverage after power on. In the beginning, UE sets the RRM mode to non-stationary mode and the SCounterₙ value 530 to 0. Since the UE is stationary and the signal is good (i.e., the prerequisite conditions of block 302 of FIG. 3 are satisfied and the one-shot detection detects stationary mode at block 304 of FIG. 3), the SCounterₙ value 530 starts to ramp up as the stationary mode counter is incremented every DRX cycle. During the ramp up, there may be some signal fluctuations which causes the SCounterₙ value 530 to fluctuate too. However, as long as the SCounterₙ value 530 does not drop to 0 (for example), the SCounterₙ value 530 continues to increase.

At time T1 represented by vertical dashed line 540, the SCounterₙ value 530 hits the L_{low} value (i.e., the threshold for transitioning from non-stationary mode to high-stationary mode, or the transition 412 of FIG. 4) represented by line 514. At this stage, the UE transitions to high-stationary mode, thereby realizing a first level of power savings by reducing RRM operations. The SCounterₙ value 530 continues to ramp up (while experiencing minor fluctuations) since the UE is still stationary. At time T2 represented by vertical dashed line 542, the SCounterₙ value 530 hits the L_{high} value (i.e., the threshold for transitioning from high-stationary mode to full-stationary mode, or the transition 414 of FIG. 4) represented by line 518. At this stage, the UE transitions to full-stationary mode, thereby realizing maximum power savings by further relaxing or suspending RRM operations. The SCounterₙ value 530 continues to increase until it hits a maximum SCounterₙ value, or SCounterₘₐₓ, at line 520.

At time T3 represented by vertical dashed line 544, the UE starts to move (the UE is non-stationary 554). As a result, the one-shot detection conditions are no longer satisfied, and the SCounterₙ value 530 starts to drop. The SCounterₙ value 530 may experience some fluctuations due to signal fluctuations or error. Eventually, at time T4 represented by vertical dashed line 546, the SCounterₙ value 530 hits line 516 representing the SCounterₘₐₓ−dₛ value (i.e., the threshold for transitioning from full-stationary mode to high-stationary mode, or the transition 416 of FIG. 4). At this stage, the UE transitions to high-stationary mode. As the UE continues to move, the SCounterₙ value 530 continues to drop. At time T5 represented by vertical dashed line 548, the SCounterₙ value 530 hits line 512 representing the SCounterₘₐₓ−dₗₘ value (i.e., the threshold for transitioning from high-stationary mode to non-stationary mode, or the transition 418 of FIG. 4). At this stage, the UE transitions to non-stationary mode. As demonstrated in FIG. 5, the sequential detection algorithm employed by the UE increases the UE's tolerance to signal fluctuation errors which otherwise would reduce the amount of time that the UE is in one of the power-saving stationary modes.

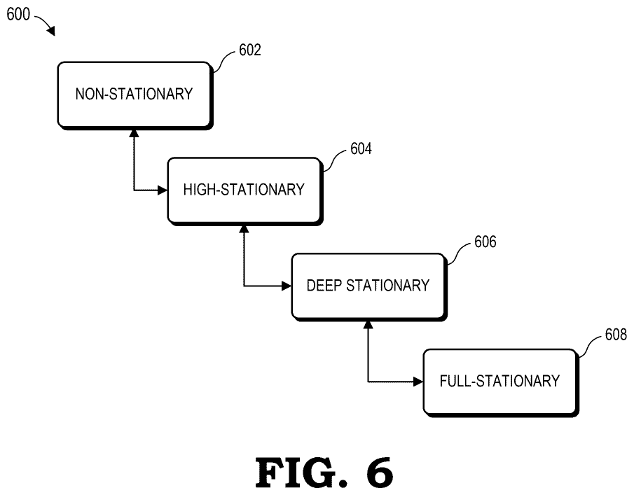

FIG. 6 shows another example of a stationary mode state transition diagram 600 in accordance with some embodiments. The stationary mode state transition diagram 600 shows the aforementioned non-stationary mode 602, high-stationary mode 604, and full-stationary mode 608 and introduces a deep stationary mode 606 between the high-stationary mode 604 and the full-stationary mode 608. The deep stationary mode 608 provides greater power saving gains than high-stationary mode 604, but less power saving gains than full-stationary mode 608. That is, in some aspects, the deep stationary mode 606 relaxes RRM operations more than the high-stationary mode, but the deep stationary mode 606 does not relax the RRM operations as much as done in full-stationary mode 608. In this manner, the deep stationary mode 608 provides an additional stage for power savings between the high-stationary mode 604 and the full-stationary mode 608. This allows the UE to increase power savings games in scenarios where the UE is in position for more power saving gains than provided in high-stationary mode 604 but the UE is not in position to enter full-stationary mode for maximum power savings gains. For example, RRM operations in non-stationary mode 602 may consume 33 milliwatts (mW), RRM operations in high-stationary mode 604 may consume 29 mW, and RRM operations in full-stationary mode 608 may consume 17 mW. Accordingly, deep stationary mode 606 introduces a step between high-stationary mode 604 and full-stationary mode 608 that allows for power consumption of RRM operations in the range between 17 mW and 29 mW. In some cases, the deep stationary mode 606 is preferable in cell edge or low mobility scenarios.

For example, to transition to deep stationary mode 606 from high-stationary mode 604, a third threshold (Lᵢₙₜ) is introduced, where L_{low}<Lᵢₙₜ<L_{high}. In addition, to transition from full-stationary mode 608 to deep stationary mode 606, a fourth threshold (SCounterₘₐₓ−dᵢₙₜ) is introduced, where dₗₘ>dᵢₙₜ>dₛ. In some embodiments, deep stationary mode 606 provides an enhanced multiplier feature to further relax the scheduling of cell search and signal measurements as compared to high-stationary mode 604. In some embodiments, high-stationary mode 604 applies the minimum requirements as defined in 3GPP TS 36.133 and 3GPP 38.133 for cell reselection search and measurement scheduling as a baseline relaxation to save power. In deep stationary mode 606, the UE is more aggressive in the scheduling relaxation by considering an enhanced multiplier M (in addition to the 3GPP minimum requirement). The M is a positive value (e.g., M=3). Thus, when in deep stationary mode 606, the actual search and measurement scheduling period is the 3GPP minimum requirement multiplied by M (e.g., 3GPP minimum requirement×3). This enables the UE to bridge the power saving gap between high-stationary mode 604 and full-stationary mode 608 in certain scenarios such as low mobility or cell edge scenarios.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
performing, at a user equipment (UE), a one-shot detection during a first time period to detect whether a first set of stationary mode conditions are satisfied to transition from a first stationary mode to a second stationary mode; and
responsive to the one-shot detection determining that the first set of stationary mode conditions are satisfied, executing, at the UE, a sequential detection during a second time period after the first time period.

2. The method of claim 1, further comprising, responsive to the sequential detection:
transitioning from the first stationary mode to the second stationary mode; or
staying in the first stationary mode.

3. The method of claim 2, wherein the first stationary mode is one of a full stationary mode which consumes a first amount of power, a deep stationary mode which consumes a second amount of power, a high stationary mode which consumes a third amount of power, and a non-stationary mode which consumes a fourth amount of power, and wherein the second stationary mode is a different one of the full stationary mode, the deep stationary mode, the high stationary mode, and the non-stationary mode.

4. The method of claim 3, wherein the first amount of power is less than the second amount of power, wherein the second amount of power is less than the third amount of power, and wherein the third amount of power is less than the fourth amount of power.

5. The method of claim 2, further comprising:
evaluating whether one or more prerequisites are satisfied prior to performing the one-shot detection, wherein the one or more prerequisites comprise determining that a serving cell has not changed from a previous cycle and detecting that a signal-to-interference-plus-noise ratio (SINR) is above a base SINR threshold.

6. The method of claim 2, wherein the first set of stationary mode conditions comprises one or more of: evaluating whether a signal-to-interference-plus-noise ratio (SINR) meets an SINR threshold and evaluating whether a reference signal received power (RSRP) variation threshold over a pre-determined number of cycles meets an RSRP variation threshold.

7. The method of claim 2, wherein the sequential detection comprises updating a counter based on the one-shot detection, wherein each count in the counter represents a discontinuous reception cycle (DRX).

8. The method of claim 7, wherein the counter is incremented responsive to the one-shot detection being satisfied and decremented responsive to the one-shot detection not being satisfied.

9. The method of claim 7, wherein the sequential detection comprises comparing the updated counter to one or more thresholds, wherein the one or more thresholds each define a counter value for transitioning between the first stationary mode and the second stationary mode.

10. The method of claim 2, further comprising triggering the one-shot detection and the sequential detection every discontinuous reception cycle (DRX) between the UE and a base station.

11. A non-transitory computer readable medium embodying a set of executable instructions, the set of executable instructions to manipulate at least one processor of a user equipment to:
perform a one-shot detection during a first time period to detect whether a first set of stationary mode conditions are satisfied to transition from a first stationary mode to a second stationary mode; and
responsive to the one-shot detection, execute a sequential detection during a second time period after the first time period.

12. A user equipment (UE) comprising:
a modem coupled to a radio frequency (RF) front end of the UE and comprising at least one processor; and
a memory coupled to the modem and storing executable instructions, the executable instructions configured to manipulate the at least one processor to:
perform a one-shot detection during a first time period to detect whether a first set of stationary mode conditions are satisfied to transition from a first stationary mode to a second stationary mode; and
responsive to the one-shot detection, execute a sequential detection during a second time period after the first time period.
